(19) United States
(12) Patent Application Publication
(10) Pub. No.: US 2013/0206292 A1
(43) Pub. Date: Aug. 15, 2013

(54) TREAD FOR A TIRE FOR A TRAILER-TYPE HEAVY VEHICLE

(71) Applicants: Benoit Foucher, Chamalleres (FR); Hervé Bechon, Pont-Du-Chateau (FR); Philippe Mansuy, Cebazat (FR)

(72) Inventors: Benoit Foucher, Chamalleres (FR); Hervé Bechon, Pont-Du-Chateau (FR); Philippe Mansuy, Cebazat (FR)

(73) Assignees: MICHELIN RECHERCHE ET TECHNIQUE S.A., Granges-Paccot (CH); COMPAGNIE GENERALE DES ETABLISSEMENTS MICHELIN, Clermont-Ferrand (FR)

(21) Appl. No.: 13/642,664

(22) PCT Filed: Apr. 27, 2011
(86) PCT No.: PCT/EP2011/056663

§ 371 Date: Dec. 5, 2012

(30) Foreign Application Priority Data
Apr. 30, 2010 (FR) 1053376

(51) Int. Cl. B60C 11/00

(52) U.S. Cl. CPC B60C 11/0083
USPC 152/209.1

(57) ABSTRACT

A tyre for heavy goods vehicle comprising a tread with a thickness E having a tread surface, an asymmetrical sculpture design over at least one thickness equal to 30% of the thickness of the tread, forming an outer portion of axial width LE to be positioned axially towards the outside of a vehicle when the tyre is fitted and an inner portion of axial width LI situated in the axial extension of the outer portion, the inner portion and the outer portion separated by a groove of generally circumferential orientation, the outer portion of the tread comprising, in the circumferential direction, a succession of rigid strips of circumferential width D11 and of axial width LE having no groove or cavity opening onto the tread surface in the new state and of flexible strips of circumferential width D12 and of axial width LE provided with grooves extending over the whole circumferential width D12 of these flexible strips, the rigid strips having a circumferential width D11 at least equal to 7% of the axial width LE of the outer portion.

### SCOPE OF THE INVENTION

The present invention relates to tyres for heavy goods vehicles and more particularly tyres designed to be fitted to the carrying axles of vehicles of the three-axle trailer type. Yet more specifically, it relates to the sculpture design of the tread of such tyres.

### DESCRIPTION OF THE PRIOR ART

A tyre for a heavy goods vehicle comprises beads designed to be in contact with a fitment rim, these beads extending radially outwards through side walls themselves being connected on either side of a crown portion, the latter being covered by a tread of which the function is to provide contact with the road when running.

Such tyres comprise a carcass reinforcement anchored in the beads, this reinforcement extending in the side walls up to the crown of the tyre. This carcass reinforcement formed of one or more reinforced plies is surmounted radially towards the outside in the crown portion of the tyre by a crown reinforcement itself formed by a plurality of reinforced plies.

The tread of a tyre has a thickness that is appropriate for a use and is also provided with a sculpture design formed of relief elements such as ribs and blocks, these elements being delimited by grooves.

Definitions of Terms Used in the Present Application:

A radial direction is a direction perpendicular to the axis of rotation of the tyre.

An axial or transverse direction is a direction parallel to the axis of rotation of the tyre.

A circumferential direction is a direction tangential to any circle centred on the axis of rotation of the tyre.

A groove is the space formed in a tread between walls of material over a depth at most equal to the thickness of the tread, these walls of material not coming into contact with one another in the usual running conditions of the tyre.

An incision is the space formed in a tread between walls of material over a depth at most equal to the thickness of the tread, the said walls being able, at least in part, to come into contact with one another in the usual running conditions of the tyre.

A relief element is a block or a rib. A relief element is delimited by grooves and has a contact face designed to come into contact with the road surface during running and lateral faces cutting the contact face along ridges.

The tread surface of a tread is the whole of the contact faces of all the relief elements of a tread.

In the present document, “nominal conditions” of use of a tyre are its conditions of use, that is to say its reference inflation pressure corresponding to its load capacity indicated by the load index and the speed code of the said tyre, this reference pressure and this load capacity being given by the E.T.R.T.O. European standard. The TRA and JATMA standards may also be used for tyre dimensions that do not appear in the E.T.R.T.O.

Amongst the heavy goods vehicles there are trailers comprising several non-steered axles, that is to say having only one orientation of the tyre/wheel assemblies mounted on these axles. These tyres can therefore not be steered to carry out turning manoeuvres. For a long time a problem has been observed associated with the movement sequence of taking a bend for each of the said axles. Although one of the axles can tangentially follow a circular trajectory, it cannot be the same for the other axles. The result of this is a more pronounced uneven wear for the tyres of these axles than for those of the axle of which the tyres follow a circular trajectory. “Uneven wear” means wear that is not uniform over the whole tread surface of the tread of a tyre and that may lead to a premature removal of the said tyre. Everything happens as if the tyres of the axles not following a circular trajectory were subjected to an induced drift causing sliding and friction of the treads on the road surface and consequently more pronounced wear.

This problem is well known and several solutions have been proposed.

U.S. Pat. No. 5,622,575 proposes a tread of which the sculpture design is asymmetrical; an inner portion designed to be positioned toward the inside of the chassis of the vehicle is provided with circumferential grooves and incisions oriented transversely and obliquely, another outer portion designed to be positioned towards the outside of the vehicle has no grooves and incisions. The latter portion comprises a plurality of cavities placed in circumferential lines.

U.S. Pat. No. 4,905,748 proposes a sculpture design combined with different radii of curvature on either side of the mid-plane of the tread, this sculpture comprising grooves of narrower widths on the outer side than on the inner side.

Although these solutions provide an improvement in the matter of uneven wear, it is found that, for tyres mounted on axles not following a circular trajectory, the outer portion of these tyres (that is to say the portion axially on the outside of their tread) is subjected to intense slippage relative to the road surface, which results in a more pronounced wear on this axially outer portion.

### SUMMARY OF THE INVENTION

One objective of the invention is precisely to improve the performance in wear of a tread of the tyres on the axles that do not tangentially follow a circular trajectory while maintaining a high level of grip for this tread.

With this objective, the tread of a tyre for a heavy goods vehicle of the trailer type comprises beads designed to be in contact with a fitment rim, these beads extending radially outwards through side walls themselves being connected on either side of a crown portion, this crown portion being covered radially outwards by a tread with a thickness E, this tread having a tread surface. This tyre comprises a carcass reinforcement anchored in the beads and extending into the side walls and into the crown portion, the crown portion of the tyre comprising a crown reinforcement.

The tread of the invention is provided with an asymmetric sculpture design over at least a thickness equal to 30% of the total thickness E of the tread, so as to form an outer portion of axial width LE and an inner portion of axial width LI. “Axial width” means, in the present application, the dimension measured in a direction parallel to the axis of rotation of the tyre. The outer portion is designed to be positioned axially towards the outside of a vehicle when the tyre is fitted on this vehicle and the inner portion in the axial extension of the outer portion towards the inside of the said vehicle.

Moreover, the inner portion and the outer portion are separated by a groove of generally circumferential orientation, this groove cutting the tread surface along two ridges, one axially outer ridge and one axially inner ridge. This tread is characterized in that:

the outer portion of the tread comprising, in the circumferential direction, a plurality of rigid strips of circumferential width D11 (measured in the circumferential direction) and of axial width LE and of flexible strips of circumferential width D12 and of axial width LE placed alternately (one flexible strip is circumferentially flanked by two rigid strips).

The rigid strips have no groove and/or cavity opening onto the tread surface in the new state and the flexible strips are provided with grooves extending over the whole circumferential width D12 of these strips. The rigid strips have a circumferential width D11 at least equal to 7% of the axial width LE of the outer portion (1).

“Circumferential width” means, in the present description, the dimension of the strip measured in the circumferential direction.

“Strip” means, in the present description, a volumic portion of tread having substantially the shape of a parallelepiped having a thickness equal to the thickness on which the sculpture according to the invention is formed.

Preferably, the axial width LE of the outer portion (measured between an axial edge of the tread and the ridge closest to said edge of the groove separating the outer portion from the inner portion of the said tread) is at least equal to 40% of the total axial width W of the tread. The total axial width W corresponds to the maximum width of the footprint of contact with the ground under nominal conditions of use of the tyre, this width being measured in the axial direction.

Yet more preferably, this axial width LE is at most equal to 80% of the total axial width W of contact of the tread.

Preferably, the circumferential width D11 of the rigid strips is at least equal to 15% of the axial width LE of the said rigid strips.

Such a sculpture design is produced on the tread between the tread surface of the tread in the new state and over a depth at least equal to 30% of the total thickness of this tread. The thickness of a tread is equal to the thickness of material that is designed to be used when running and before removal of the tyre provided with this tread with a view to a retreading process or of a final removal. Preferably, this depth is at least equal to 50% of the total thickness of the tread. Naturally, this sculpture design can be produced over the total thickness E of the tread.

The proposed sculpture design makes it possible to have simultaneously a great mechanical rigidity of the tread over the axially outer portion of the tread (corresponding to the axial width of the rigid strips) while having an appropriate grip under transverse force and on a water-covered road surface by virtue of the presence of the grooves or cavities formed on the flexible strips, these cavities serving as drainage reservoirs.

It is therefore possible to obtain simultaneously:

an improvement in wear performance and in evenness of wear,

a better resistance to the lateral stresses exerted on the tyre (notably during manoeuvres leading to a scrubbing/slipping relative to the ground),

satisfactory grip on water-covered ground for the type of use concerned.

In a variant of the invention, the outer portion comprises at least one incision of generally circumferential orientation, this at least one incision being closed in the contact of the tyre with the ground. This provides additional ridges without there being a substantial modification in the rigidity of the strips whether they be rigid or flexible.

The circumferential incision closest to the axially outer edge of the outer portion of the tread delimits with this axially outer edge an edge rib of which the average width is preferably at least equal to 10% of the total width W of the tread. Note in passing that the sculpture according to the invention makes it possible to reduce this width of the edge rib in comparison with the usual sculptures for this type of tyre fitted to heavy goods vehicle trailers.

Preferably, if P is the total of the circumferential widths D11 and D12 of the rigid and flexible strips of the outer portion, then the circumferential width D11 of each rigid strip is chosen to be at least equal to 25% of the total P of the circumferential widths and at most equal to 75% of the said total P.

It is advantageous to have in the contact footprint measured in the conditions of use of the tyre as defined in the E.T.R.T.O. standard at least two rigid strips and at least two flexible strips.

Preferably, each flexible strip is provided with grooves or cavities situated, relative to the axially outer edge of the tread, at an axial distance of more than 30% of the axial width LE of the said strip, this distance being measured relative to the axially outer edge of the outer portion of the tread.

In order to ensure that this type of sculpture is longer lasting and has good drainage, it is advantageous to provide radially inside the sculpture according to the invention, which extends over only a portion of the thickness of the tread, a complementary sculpture formed of channels connected to the cavities opening onto the tread surface of the tread in the new state. These channels connected to the cavities may be oriented circumferentially and/or transversely in order to ensure drainage of the water and of the air captured in the cavities in the new state and up to a wear of the tread corresponding to the depth of the initial sculpture (that is to say to the depth of the cavities opening onto the tread surface in the new state). After partial wear of the tread, corresponding to at least 30% of the thickness of the tread, these channels open onto the tread surface to form new cavities and possibly new grooves.

In order to correctly position the outer portion of the tread axially towards the outside of the vehicle, it is worth while to provide on these tyres a marking indicating the position of fitment of the tyre on a heavy goods vehicle with several non-steered axles. This marking makes it easier to install the tyre on the vehicle according to the invention.

Advantageously, the tread according to the invention also consists of two different materials placed in the width of the said tread. The separation between these materials is preferably located at the groove of generally circumferential orientation axially separating the inner portion from the outer portion in order to limit a possible difference in wear between the inner and outer portions.

These different materials are chosen in order, in combination with each portion (inner or outer), to give the tyre an advantage in terms of performance. For example, the material forming the inner portion of the tread is chosen to have a better grip performance on wet ground compared with that of the material forming the outer portion. Preferably, the difference in performance in the standard test ISO 15222 carried out with an analytical vehicle is at least 10% between the two materials.

By adopting this material for the inner portion, it is then possible to choose, for the material of the outer portion, a material having a greater resistance to wear by scrubbing or sliding compared with that of the material of the inner portion. This resistance to wear by scrubbing is evaluated in a low-speed running test on a circle with a radius equal to 15 m and in which the loss of weight by wear is measured for a number of revolutions that is fixed in advance.

Thus, by virtue of the sculpture design of the tread according to the invention, it is Possible to make the materials forming the said tread best suited to reinforcing the beneficial effects of this design on the running performance.

Other features and advantages of the invention will emerge from the description made below with reference to the appended drawings which show, as non-limiting examples, embodiments of the subject of the invention.

### BRIEF DESCRIPTION OF THE FIGURES

FIG. 1 shows a partial plan view of a variant of the tread according to the invention;

FIG. 2 shows a section along the line II-II taken from FIG. 1;

FIG. 3 shows a section along the line taken from FIG. 1;

FIG. 4 shows a partial plan view of a second variant of a tread according to the invention;

FIG. 5 shows a section along the line V-V taken from FIG. 4;

FIG. 6 shows a section along the line VI-VI taken from FIG. 4.

### DESCRIPTION OF THE FIGURES

For the figures accompanying this description, the same reference symbols may be used to describe variants of the invention when these reference symbols refer to elements of the same nature, whether that nature be structural or functional.

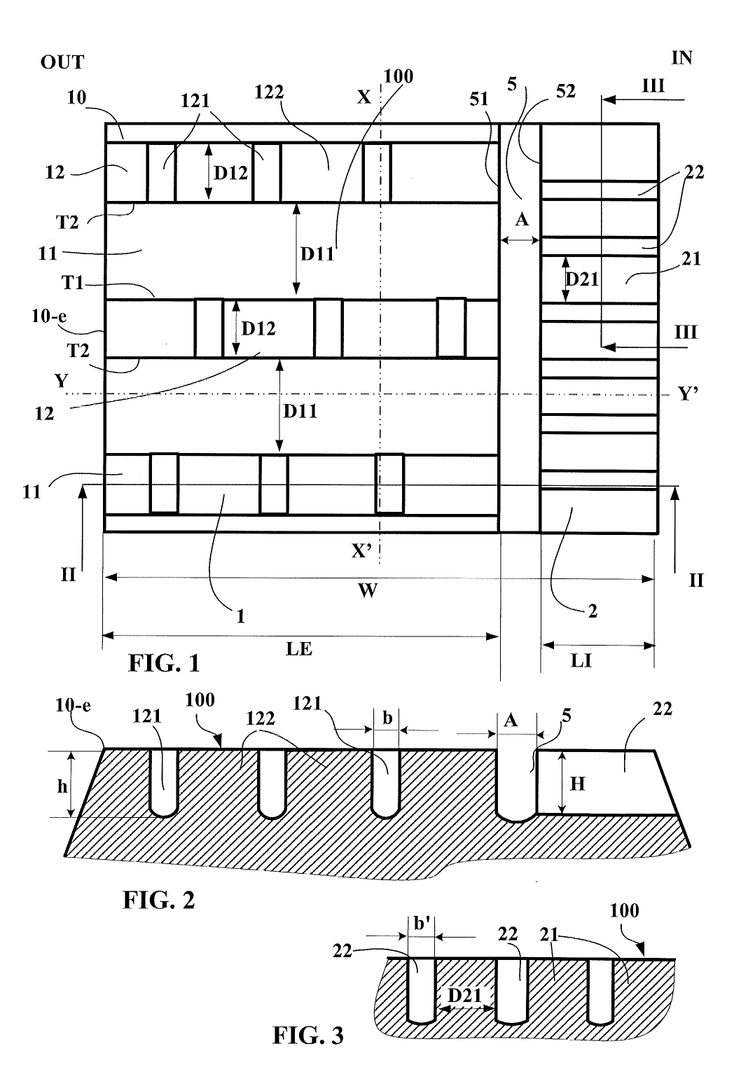

FIG. 1 shows a portion of a tread surface 100 of a tread 10 according to the invention. This tread surface 100 has a width W which corresponds to the average width of the contact footprint of the tyre with a road surface, this width W being obtained for nominal conditions of use of the tyre at zero speed.

The tread 10 has a total thickness E corresponding to the thickness that can be worn throughout the use of a tyre provided with this tread. This tread comprises a rectilinear groove 5 of circumferential orientation (indicated by the direction XX′); this groove 5 has a width A and a depth H and it forms two ridges 51, 52 on the tread surface 100, these ridges being parallel to the direction XX′. This groove 5 delimits on one side a portion 1 of axial tread width LE and on the other side a portion 2 of axial width LI. The portion of axial width LE is called the outer portion 1 and the axial portion of axial width LI is called the inner portion 2. These two axial widths LE and LI are not equal and the outer portion 1 of axial width LE, in the present case greater than the axial width LI of the inner portion 2, is designed, once the tyre provided with this tread is fitted to a heavy goods vehicle, to be situated axially on the outside of the vehicle (indicated by “OUT” in the figure). The axial width LE is measured between the ridge 51 closest to the mid-line of the tread and the axially outer edge of the said tread. The axial width LI is measure between the ridge 52 furthest from the mid-line of the tread and the axially inner edge 10-e of the said tread.

On the outer portion 1 of axial width LE there is a plurality of cavities 121 placed evenly both in the axial direction (that is to say in the transverse direction) and in the circumferential direction. In the present case, these cavities 121 have an average depth equal to that of the circumferential groove 5 and they are placed in each flexible strip in groups of 3 in the axial direction (indicated by the direction YY′). Formed on each flexible strip and between these cavities 121 are solid portions 122, that is to say portions with no cavity.

The cavities 121 of each group are delimited in the circumferential direction by virtual straight lines T1 and T2 parallel to the axial direction YY′. In the circumferential direction, the three cavities 121 of each group are placed so that they are offset from one another in the axial direction relative to each group situated circumferentially on either side.

These virtual straight lines T1 and T2 parallel to the axial direction YY′ are constructed to be tangential to the contour of the cavities of each group; these straight lines T1 and T2 delimit the strips that are called “flexible” because of the presence of the cavities 121 and strips that are called “rigid” because of the absence of cavities.

This therefore creates an alternation of rigid strips 11 and flexible strips 12 in the circumferential direction.

“Rigid strips” mean here that under the action of a force oriented in the axial direction YY′ and being exerted on the tread surface of the outer portion 1, the rigid strips 11 provide substantially the rigidity of the rubber material in a volume corresponding to the volume of the said rigid strips that are present in the contact with the road surface, therefore with no cavity. In the example described here and as already indicated, the rigid strips 11 and the flexible strips 12 have a thickness equal to the thickness of material to be worn that is substantially equal to the depth H of the circumferential groove 5.

Each flexible strip 12 has an axial width LE in the direction YY′ and a circumferential width D12 in the direction XX′. Each rigid strip 11 has the same axial width LE and a circumferential width D11 in the direction XX′. In the present case, the circumferential width D11 of the rigid strips is greater than the circumferential width D12 of the flexible strips by approximately 50%.

On the inner portion 2 of axial width LI (indicated by “IN” in FIG. 1), a plurality of grooves is provided of transverse orientation (that is to say parallel to the axial direction YY′); these grooves 22 delimit ribs 21 of elongate shape and of axial width LI and of appropriate circumferential width D21. These ribs 21 have no cavities or grooves.

By virtue of this sculpture design in the new state, the axially outer portion provides to the transverse stresses of the road surface on the tread, notably in the scrubbing configuration associated with the taking of a bend, a large degree of rigidity by virtue of the presence of the rigid strips flanking the flexible strips, the latter by virtue of the presence of the cavities making it possible to have a satisfactory performance on water-covered road surfaces in rainy weather.

In order to take the maximum benefit of the technical effect of the invention, it is preferable that, when passing in contact with the road surface, there are always at least two flexible strips and two rigid strips on the outer portion.

FIG. 2, showing a section of the tread produced along a line II-II of FIG. 1, shows that the cavities 121 of the flexible strips 12 have a width b and a depth h. This depth h is in this instance equal to the depth H of the circumferential groove 5.

FIG. 3 shows the same tread along a sectional line taken from FIG. 1. It shows a plurality of transverse grooves 22 of width b′ delimiting ribs 21 of width D21.

In the present case and as can be found in FIG. 1, there is no specific relationship between the circumferential widths of the ribs 21 and that of the rigid strips 11 of the outer portion of the tread.

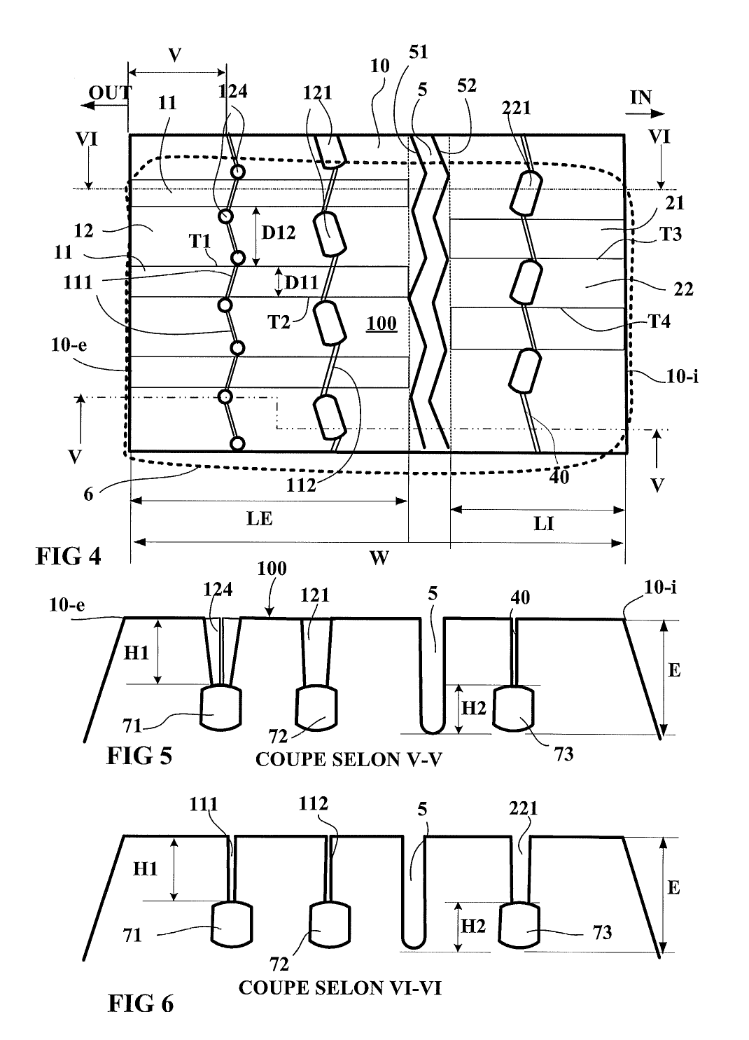

In another variant embodiment shown with FIGS. 4, 5 and 6, the tread 10 according to the invention is designed for a tyre of dimension 385/55 R22.5. This tread 10 has a total width W equal to 320 mm and comprises a main groove 5 in a zigzag of circumferential orientation opening onto the tread surface 100 following two ridges 51, 52 both having peaks and hollows. This main groove 5 has an average width of 13 mm (measured as the average distance separating the facing walls delimiting this groove) and a depth equal to 15 mm. This main groove 5 divides the tread into two portions of different axial widths: an outer portion 1 of axial width LE designed to be placed axially towards the outside of the vehicle and an inner portion 2 of axial width LI designed to be placed towards the inside of the vehicle. The axial width LI is taken between an axially outer edge 10-e of the tread and the peaks of the ridge 51 delimiting the circumferential groove 5, the said ridge 51 corresponding to the ridge situated axially outermost once in place on the vehicle. This axial width LI is in this instance equal to 190 mm (or 60% of the total width W).

The inner portion 2 (marked “IN”) and the outer portion I (marked “OUT”) are provided with hollows or cavities, respectively 221 and 121, which have a width equal to 14 mm, measured on the tread surface 100 in the new state, and a maximum length equal to 34 mm. These cavities, with a depth equal to 10 mm in the present example, are also formed with an average uniform angle of relief of 16.5°, so as to progressively reduce the section of each cavity opening onto the tread surface gradually as the tread wears. Moreover, the outer portion 1 comprises a plurality of pits 124 of the same depth as the cavities 121, these pits being placed in the circumferential direction so as to form, in combination with the cavities 121, flexible strips and rigid strips. These pits 124 have a conical shape and are connected to a circumferential channel 71, that can be seen in FIG. 5, formed beneath the tread surface, this channel 71 being designed to form a new groove after partial wear of the tread. The cavities 121 are extended radially inwards by a channel 72 oriented circumferentially.

“Rigid strip” in this instance means that, under the action of the transverse forces of the ground on the tread when turning or in a steering manoeuvre, the incisions of circumferential orientation are closed or close very rapidly to generate a tread of virtually continuous material and therefore of maximum rigidity. Conversely, the strips comprising the cavities are called flexible because, under the action of a transverse force, the apparent rigidity of these strips is a function of the closure to a greater or lesser degree of these cavities and is in any case much less than that of the rigid strips.

Straight lines T1 and T2 parallel to the axial direction YY′ and tangential to the cavities 121 or to the pits 124 delimit rigid strips 11 with no cavities and pits and flexible strips 12 provided with cavities and pits.

The flexible strips 12 and the rigid strips 11 of the outer portion of the tread are also provided with an incision 112 forming zigzags and extending in the circumferential direction in order to connect the cavities 121. This incision 112 has an appropriate width in order to be able to close from the tread surface and over a great depth (that is to say at least 30% of the thickness of the tread) when passing in contact with the road surface in order to place the facing walls in contact and thus obtain a large degree of rigidity for the rigid strips 11. Axially on the outside of this incision, note the presence of another incision 111 in a zigzag, this incision connecting together the plurality of pits 124 formed radially in the depth of the tread.

Everything happens as if these incisions 111 and 112 made practically no change to the transverse rigidities of each rigid strip and of each flexible strip because these incisions close when passing into the contact zone when running. Thus, it is possible to benefit from the presence of supplementary ridges without modifying the rigidities of the flexible strips and of the rigid strips. During a turning manoeuvre that can generate a phenomenon of a scrubbing on the road surface, the transverse forces of contact exerted by the road surface on the tread are to a large degree transmitted by the rigid strips 11, the incisions 111 and 112 being closed on themselves.

Each flexible strip has a circumferential width D12 equal to 40 mm. And each rigid strip has a circumferential width D11 equal to 25 mm (or 13% of the axial width LE of the outer portion). Superposed onto the design of the tread in the new state shown in FIG. 4 is the contour 6 of the contact footprint of the tyre of dimension 385/55 R22.5 at its nominal conditions (that is to say inflated to its reference pressure and supporting a load as defined by the E.T.R.T.O. standard). In the nominal conditions of this tyre (pressure equal to 9 bar, load equal to 4500 daN), the footprint has a length in the circumferential direction that is equal to 155 mm. By virtue of the dimensions chosen for the flexible and rigid strips, there are always at least two rigid strips in contact with the road surface in order to withstand the transverse forces and at least two flexible strips, that is to say an appropriate number of cavities serving as a reservoir to capture the water that is present on the road surface in times of rain. In the situation shown, observe the presence in the footprint of three flexible strips and three rigid strips.

On the inner portion 2 of axial width LI there is a zigzag incision 40 of generally circumferential orientation. This incision 40 is situated substantially half-way between the axially inner edge 10-i of the tread and the ridge 52 of the groove 5. This incision connects a plurality of cavities 221. This incision 40 is capable, through its dimensions, of closing when passing in contact with the road surface when running. The cavities 221 of the inner portion 2 are circumferentially offset relative to the cavities 121 of the outer portion 1. Thus, a succession of rigid strips 21 of circumferential width D21 and of flexible strips 22 of circumferential width D22 is formed on the inner portion 2, these portions being delimited by straight lines T3 and T4 parallel to the axial direction YY′ and tangential to the cavities 221. These rigid and flexible strips of the inner portion 2 are placed in alternation and so as to be offset circumferentially relative to the rigid strips 11 and flexible strips 12 of the outer portion 1.

In addition to the advantage in turning manoeuvres, the sculpture according to the invention makes it possible to reduce the hollow volumes present on the tread in the initial state and therefore to reduce substantially the thickness of the tread for a predetermined overall volume.

In this variant, the volumes of the hollows and pits on the outer portion 1 are distributed so that these volumes increase gradually from the axially outermost edge of the tread in the direction of the other edge of the outer portion 1 in order to be at a maximum at the circumferential groove 5. The same applies, but in the opposite direction, to the inner portion 2 starting from the axially innermost edge relative to the vehicle and in the direction of the circumferential groove.

Advantageously, the incision 111 that is axially outermost of the outer portion 1 is at an average axial distance V from the outer edge of the tread that is at least 10% of the total width W of the tread. Specifically it has been found, surprisingly when compared with what is observed with the treads of the prior art, that the sculpture according to the invention made it possible to position this incision closer to the axially outer edge of the tread while having a satisfactory resistance to damage on the outermost portion of the tread. In the present case, the incision 111 is situated at an average distance equal to 64 mm (or 20% of the width W=320 mm).

In order to obtain lasting wear performance, a second portion is provided, after a first portion of sculpture according to the invention, in the thickness of the tread that is not according to the invention. This second portion becomes active in contact with the road surface after wear of the portion comprising a sculpture according to the invention. This second portion in the thickness comprises cavities 71, 72, 73 (visible in FIGS. 5 and 6) designed to open onto the new tread surface after partial wear in order to form in the usual manner grooves in at least one direction.

After partial wear, the tread then exhibits four grooves that are open onto the tread surface as can be seen in FIGS. 5 and 6 which show sections along the lines V-V and VI-VI respectively, taken from FIG. 4.

Seen in FIG. 5 and in FIG. 6, after a depth H1 corresponding to the depth of the cavities 121, 221 and of the pits 124, is the formation of channels 71, 72, 73 which, by opening onto the tread surface after partial wear corresponding to the depth H1, equal in this instance to 10 mm, form three new grooves of circumferential orientation and of depth H2, equal to 5 mm. In this variant, the sculpture according to the invention is present and active over a thickness H1 that is in this instance substantially equal to 66% of the total thickness equal to 15 mm of material to be worn.

In the present case, it should be considered that the sculpture according to the invention is present between the tread surface in the new state and a depth H1 from which new grooves appear.

The invention described with the support of these two variants should not be limited to these two variants and various modifications can be made thereto without departing from its context. Notably, the circumferential widths of the rigid strips (or of the flexible strips) that are shown to be constant in the two variants described may be different on wheel revolution while complying with the preferred value ranges. It is even an advantage to be able to vary these widths in order to obtain a reduction in running noise.

1. A tire for heavy goods vehicle of the trailer type comprising:
beads designed to be in contact with a fitment rim, these beads extending radially outwards through side walls themselves being connected on either side of a crown portion, this crown portion being covered by a tread with a thickness E having a tread surface, this tire comprising a carcass reinforcement anchored in the beads, this reinforcement extending into the side walls and into the crown portion, the crown portion of the tyre comprising a crown reinforcement,
the tread is provided with an asymmetrical sculpture design over at least one thickness equal to 30% of the thickness of the tread, so as to form an outer portion of axial width LE designed to be positioned axially towards the outside of a vehicle when the tire is fitted on this vehicle and an inner portion of axial width LI situated in the axial extension of the outer portion,
the inner portion and the outer portion being separated by a groove of generally circumferential orientation, this groove cutting the tread surface along two ridges, one axially outer ridge and one axially inner ridge,
the outer portion of the tread comprises, in the circumferential direction, a succession of rigid strips of circumferential width D11 and of axial width LE having no groove or cavity opening onto the tread surface in the new state and of flexible strips of circumferential width D12 and of axial width LE provided with grooves extending over the whole circumferential width D12 of these flexible strips,
the rigid strips having a circumferential width D11 at least equal to 7% of the axial width LE of the outer portion.

2. A tire according to claim 1, wherein the rigid strips have a circumferential width D11 at least equal to 15% of the axial width LE of the outer portion.

3. A tire according to claim 1, wherein the axial width LE of the outer portion is at least equal to 40% of the width W of the tread.

4. A tire according to claim 3, wherein the axial width LE of the outer portion is at most equal to 80% of the total contact width W of the tread.

5. A tire according to claim 1, wherein the outer portion comprises at least one incision of generally circumferential orientation, this at least one incision being closed in the contact of the tire with the road surface.

6. A tire according to claim 5, wherein the incision formed on the outer portion is situated relative to the axially outermost edge of the tread at an average distance at least equal to 10% of the total width W of the tread.

7. A tire according to claim 5, wherein the outer portion comprises at least one incision of generally circumferential orientation, this at least one incision being closed in the contact of the tire with the ground, and this at least one incision connecting together a plurality of cavities situated in the flexible strips, these cavities not closing in the contact.

8. A tire according to claim 1, wherein each flexible strip comprises a plurality of cavities oriented essentially in the circumferential direction, these cavities being distributed in the axial direction so as to be offset axially from the other cavities situated circumferentially on either side.

9. A tire according to where claim 1, wherein P is the total of the circumferential widths D11 and D12 of the rigid strips and of the flexible strips, the circumferential width D11 of the rigid strip is at least equal to 25% of the total P and at most equal to 75% of the said total P.

10. A tire according to claim 1, wherein the tread also consists of two different materials placed in the width of the said tread.

11. A tire according to claim 10, wherein the separation between the two materials is located at the groove of generally circumferential orientation axially separating the inner portion from the outer portion.

12. A tire according to claim 10, wherein the material forming the inner portion of the tread has a grip on wet ground that is at least 10% greater than the grip on wet ground of the material forming the outer portion, this grip being measured according to a standard test ISO 15222 and in that the resistance to wear by a scrubbing of the material of the outer portion is greater than the resistance to wear by scrubbing of the material of the inner portion.

13. A tire for heavy goods vehicle according to claim 1, comprising a marking indicting the position of fitment of the tire on a heavy goods vehicle with several non-steered axles, so as to correctly position the outer portion of the tread axially towards the outside of the vehicle.
